(19) United States
(12) Patent Application Publication
(10) Pub. No.: US 2023/0140805 A1
(43) Pub. Date: May 4, 2023

(54) NETWORK PATH SELECTION IN A SINGLE SERVICE SET ID

(71) Applicant: ROKU, INC., San Jose, CA (US)

(72) Inventors: Amalavoyal Narasimha CHARI, San Jose, CA (US); Allen WONG, San Jose, CA (US); Tito THOMAS, San Jose, CA (US); Sudipto NANDI, San Jose, CA (US); Jason SCHMIDLAPP, San Jose, CA (US); Erwan SUTEAU, San Jose, CA (US); Richard JØRGENSEN, San Jose, CA (US); Lizhi XUE, San Jose, CA (US)

(73) Assignee: ROKU, INC., San Jose, CA (US)

(21) Appl. No.: 17/939,494

(22) Filed: Sep. 7, 2022

Related U.S. Application Data
(60) Provisional application No. 63/246,723, filed on Sep. 21, 2021.

(51) Int. Cl. H04W 48/20; H04W 28/22; H04W 28/20; H04B 17/318; H04W 40/12

(52) U.S. Cl. CPC H04W 48/20; H04W 28/22; H04W 28/20; H04B 17/318; H04W 40/12

(57) ABSTRACT

This disclosure is generally directed to improving path selection within a network having a single service set identifier (SSID), and more particularly, toward a media device selecting an access point from a group of access points on the same SSID based on composite metrics generated for each access point. The composite metrics may be based on network capabilities of the media device and the respective access points in the group of access points.

### CROSS-REFERENCE TO RELATED APPLICATIONS

This application claims priority to U.S. Provisional Patent Application No. 63/246,723 (Attorney Docket No. 3634.2730000), filed Sep. 21, 2021, titled “Improved Network Path Selection in a Single Service Set ID,” the contents of which are hereby incorporated herein by reference in its entirety.

### BACKGROUND

### Field

This disclosure is generally directed to improving path selection within a network having a single service set identifier (SSID), and more particularly, toward selecting an access point from a group of access points on the same SSID.

### Background

Home networks with multiple access points have increased in popularity as the increase in the number of access points allows a network signal to be accessible throughout a user's home. For example, a user may place one access point on the first floor and another access point on the second floor of a house. This configuration allows network coverage throughout the house.

Devices connecting to such a network having multiple access points face a decision regarding which access point in the network should be used for connections. Conventional selection relied on the signal strength (RSSI) of each access point. The assumption being that the stronger the signal strength, the more likely that the access point would provide a strong connection and therefore, better network performance than an access point with a weaker strength.

This conventional approach does not take into account a number of factors, beyond signal strength, that may impact network performance. Accordingly, devices that connect to an access point based solely on signal strength may face degraded network performance.

What is needed is an improved mechanism for evaluating access points in a network and providing a more accurate predictor of network performance for each access point to improve the access point selection process.

### SUMMARY

Provided herein are system, apparatus, article of manufacture, method and/or computer program product embodiments, and/or combinations and sub-combinations thereof, for selecting access points within the same network based on a composite metric generated for each access point. Additional embodiments include incorporating trigger conditions based on a configurable frequency and changes in network conditions which may be used to initiate an access point selection process for selecting a new access point based on the composite metrics associated with each available access point. The composite metric may also be used as part of a process for selecting a wireless network among available wireless networks by ranking each wireless network based on the composite scores of their respective access points.

### BRIEF DESCRIPTION OF THE FIGURES

The accompanying drawings are incorporated herein and form a part of the specification.

FIG. 1 illustrates a block diagram of a multimedia environment with multiple access points associated with a network SSID, according to some embodiments.

FIG. 2 illustrates a block diagram of a network environment, according to some embodiments.

FIG. 3A illustrates a block diagram of a BSSID processor that may be implemented in a media device for evaluating and selecting access points, according to some embodiments.

FIG. 3B illustrates an exemplary determination of a reliability metric for two access points, according to some embodiments.

FIG. 4 is a flowchart illustrating a method for selecting a best candidate access point, according to some embodiments.

FIG. 5 is a flowchart illustrating a method for collecting information for generating a composite metric for access points in a given network, according to some embodiments.

FIG. 6 is a flowchart illustrating a method for generating a composite metric based on collected information for access points in a given network, according to some embodiments.

FIG. 7 is a flowchart illustrating a method for selecting an access point based on the composite metric of each access point, according to some embodiments.

FIG. 8 is a flowchart illustrating a method for initiating periodic AP selection, according to some embodiments.

FIG. 9 is a flowchart illustrating a method for initiating AP selection based on a detected trigger condition, according to some embodiments.

FIG. 10 is a flowchart illustrating a method for selecting a network based on composite metric of associated access points in the network, according to some embodiments.

FIG. 11 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for improved access point selection within a given network. Where conventional AP selection is limited to selecting access points based primarily on an access point's signal strength (i.e., RSSI), the present disclosure describes an access point selection process that uses a composite metric, known as a speed score, that takes into account a variety of different available metrics associated with each access point in a network. Particular embodiments relate to selecting an access point based on the calculated speed score (rather than the access point's signal strength). By decoupling an access point's signal strength from the selection process (and incorporating that information into the composite metric), embodiments in this disclosure provide a means for selecting access points based on a more intelligent estimation of network performance.

Devices that connect using the conventional method typically run into network performance issues because the conventional method ignores other metrics that impact network performance. That is, connections with a higher signal strength may have lower performance metrics including noise, congestion, or actual achievable speeds at the access point.

As an example, a home network may use a dual radio access point that provides both 2.4 GHz and 5 GHz connections. Devices in the home network typically connect using the 2.4 GHz connection which may have a stronger signal strength than the 5 GHz connection. But historical use suggests that 2.4 GHz connections, because more devices connect to them based on their signal strength, have higher congestion and noise that impacts streaming performance. Similarly, 2.4 GHz connections may have slower achievable speeds (e.g., limited to 11n) when compared to 5 GHz speeds (e.g., capable of 11ac). To sum, a connection (e.g., 2.4 GHz) may have a stronger signal but perform poorly during network usage.

Another possible issue with conventional access point selection involves certain devices in a home network involving lower power devices such as set-top boxes and media streaming devices which utilize lower power processors when compared to high-power devices such as smartphones and tablets. It should be noted that what may be considered a high-power device at one point in time may eventually be considered to be a low-power device as technology continually advances (e.g., in 2-3 years). Because what may be considered a fast processor and/or sufficient graphics memory eventually is replaced with an even faster processor and/or even more graphics memory. In that sense, the concept of a low-power device and a high-power device is relative. Accordingly, in some embodiments, a lower power device may be considered to be a device that conventionally utilizes a lower power processor relative to other contemporaneous devices. For example, to conserve costs, a set-top box or a media streaming device may utilize a slower processor (e.g., lower power processor or older model processor) compared to a smartphone that may utilize a faster processor (e.g., newest processor). In some embodiments, a media device may refer to a dedicated streaming device that is optimized to perform tasks associated with a media streaming such as, streaming media content, processing media content, and displaying the media content such as via a graphical user interface.

Access point selection for such devices in a home network can be sticky. Once such devices connect to an access point, there is no mechanism to later detect whether an access point that can provide better network performance has become available (e.g., temporary unavailability due to a reboot) after that initial connection to the first access point. Currently, devices only perform an access point scan during bootup, resuming from a suspended more, or after a dropped connection. Accordingly, outside these conditions, even if network performance degrades, the device remains connected to the access point.

Utilizing additional network metrics provides its own challenges however. For example, noise and congestion may be spiky and reflect only temporary network conditions which could impact the long-term accuracy of any predictions. Accordingly, it is not simply a matter of utilizing this additional information as part of the selection process. The network metrics can be used intelligently along with known capabilities of both media devices and access points in order to provide a more accurate prediction of network performance for each access point. The primary goal is to maximize the network performance between the media device and the access point. Another goal is to minimize the amount of times the AP selection process can be performed while maximizing the network performance between the media device and the access point.

Embodiments of this disclosure improve upon conventional access point selection by introducing the concept of a composite metric for ranking access points and for initiating access point selection as needed based on network conditions for improved network performance. The composite metric may take into account a variety of different network factors including signal strength, noise, congestion, connection reliability, and achievable speeds at the access point and therefore provides a more accurate value from which devices can select access points. The composite metric represents an estimation of the network performance of the access point. In some embodiments, the composite metric may be calculated as a maximum achievable downlink data rate for that access point.

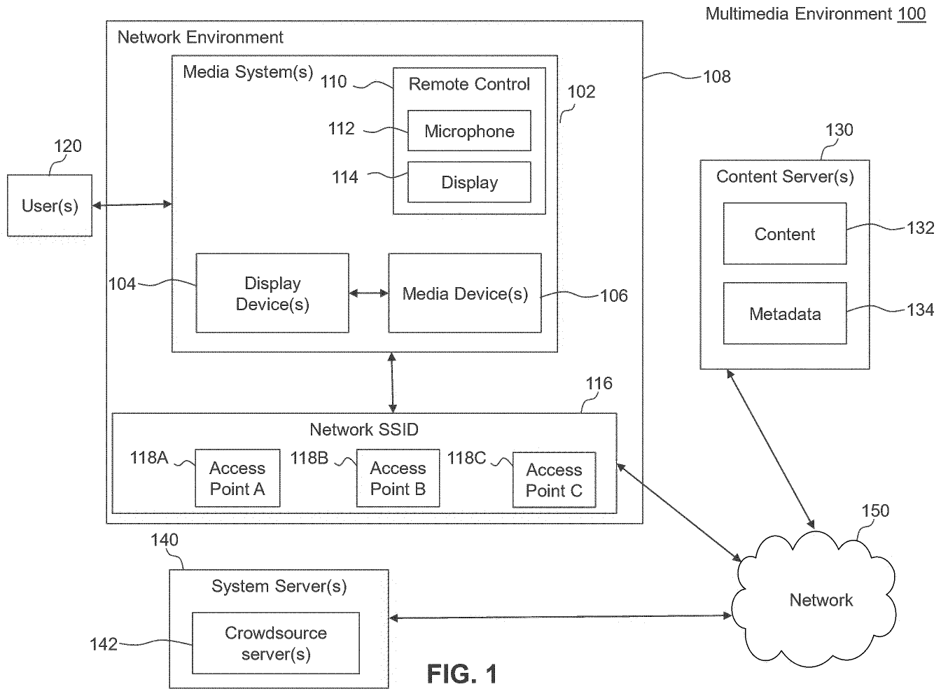

Various embodiments of this disclosure may be implemented using and/or may be part of a multimedia environment 100 shown in FIG. 1, in some embodiments. It is noted, however, that multimedia environment 100 is provided solely for illustrative purposes, and is not limiting. Embodiments of this disclosure may be implemented using and/or may be part of environments different from and/or in addition to the multimedia environment 100, as will be appreciated by persons skilled in the relevant art(s) based on the teachings contained herein. An example of the multimedia environment 100 shall now be described.

Multimedia Environment

FIG. 1 illustrates a block diagram of a multimedia environment 100, according to some embodiments. In a non-limiting example, multimedia environment 100 may be directed to streaming media across a network, such as from a server (e.g., content server 130) to a media system (e.g., media system 102). However, this disclosure is applicable to any type of media (instead of or in addition to streaming media), as well as any mechanism, means, protocol, method and/or process for distributing media.

The multimedia environment 100 may include one or more media systems 102 which may be implemented within a network environment 108. A media system 102 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. A network environment 108 could represent multiple rooms within a house (e.g., family room, kitchen, bedrooms, and basement) or public space.

A network environment 108 could further include a network SSID 116 that represents a wireless network to which devices in media system(2) 102 may connect. While only one network SSID 116 is shown in network environment 108, it is understood that network environment 108 could be implemented with any number of available network SSIDs that would operate in a similar as network SSID 116, the features of which are discussed throughout this disclosure. In some embodiments, network SSID 116 is implemented as a mesh network in which multiple access points act as a single Wi-Fi network under a single SSID.

In some embodiments, a network SSID 116 may include multiple access points such as, but not limited to, access point A 118A, access point B 118B, and access point C 118C. Each access point installed in network SSID 116 may be associated with a unique basic service set identifier (BSSID). Devices in media system 102, such as display device 104 and media device 106, may connect to network SSID 116 via one of the access points in order to stream content, such as from content server 130 via network 150.

User(s) 120 may operate the media system 102 to select and consume content. For example, user(s) 120 may interact with remote control 110 via a graphical user interface on the remote control 110, physical inputs on the remote control 110, or microphone 112, to select content for streaming.

Each media system 102 may include one or more media devices 106 each coupled to one or more display devices 104. It is noted that terms such as “coupled,” “connected to,” “attached,” “linked,” “combined” and similar terms may refer to physical, electrical, magnetic, logical, etc., connections, unless otherwise specified herein.

Media device 106 may be a device that relays media content such as a streaming media device, a set-top box, DVD or BLU-RAY device, a sound bar, audio/video playback device, cable box, and/or digital video recording device, to name just a few examples. Display device 104 may be a monitor, television (TV), computer, smart phone, tablet, wearable device (such as a watch or glasses), appliance, internet of things (IoT) device, and/or projector, to name just a few examples. In some embodiments, media device 106 can be a part of, integrated with, operatively coupled to, and/or connected to display device 104.

Each media device 106 and display device 104 may be configured to communicate with network 130 via an access point in network SSID 116. In some embodiments, access points, such as access point A 118A, access point B 118B, and access point C 118C, act together as a single Wi-Fi network and may be implemented as a router, extender, or any other device within the network that provides network access to devices in network environment 108.

In various embodiments, network 150 provides connections between network environment 108, content server 130, and system server 140, and can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 102 may include a remote control 110. The remote control 110 can be any component, part, apparatus and/or method for controlling the media device 106 and/or display device 104, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 104 using cellular, Bluetooth, infrared, etc., or any combination thereof. The remote control 110 may include a microphone 112, which is further described below. The remote control 110 may further include a display 114 for displaying a graphical user interface that enables user selection of content to be provided by media device(s) 106. In an embodiment, the graphical user interface is provided by remote control application (not shown) installed in remote control 110. Display 114 may be of various size depending on the remote control 110.

The remote control application may be installed on remote control 110 and may be configured to display a user interface for accessing content via media device(s) 106. The user interface may provide any means for allowing user(s) 120 to view, select, and otherwise identify content to be streamed by media device(s) 106. The user interface may include a predefined dimension (e.g., to fit the size of display 114) and predefined configuration that implements particular user interface elements at specific positions in the user interface. For example, the predefined configuration may implement a particular layout for a direction pad, volume controls, and other user interface elements for interacting with media content. The application may further include means for implementing an interface customization parameter that modifies the predefined dimension and/or the predefined configuration by, for example, either reducing the dimension to a smaller size or modifying the layout so that different user interface elements are displayed at different positions of the user interface.

In an embodiment, the remote control application may also include means for monitoring local user interface usage information by user(s) 120. For example, the remote control application 116 may track how often certain user interface elements are used and the store this history in memory. These user interface elements include a direction pad and buttons for controlling the media content. In an embodiment, the usage information may be implemented as a ranked list identifying how often certain interface elements are used by user(s) 120. For example, the usage information may indicate that user(s) 120 uses the volume buttons—volume up, volume down, mute—more than other interface elements. The application may transmit the usage information to crowdsource server(s) 142.

Buttons may allow users to control playback of media content and provide access to other tools such as user settings, network settings. Another example a user interface element is a slider which may provide more granular control over playback (e.g., rewind or fast forward) or settings (e.g., adjusting volume, brightness, etc.)

The multimedia environment 100 may include a plurality of content servers 120 (also called content providers or sources). Although only one content server 130 is shown in FIG. 1, in practice the multimedia environment 100 may include any number of content servers 120. Each content server 130 may be configured to communicate with network 130.

Each content server 130 may store content 122, metadata 124, and application packages 126. Content 122 may include any combination of music, videos, movies, TV programs, multimedia, images, still pictures, text, graphics, gaming applications, advertisements, programming content, public service content, government content, local community content, software, applications, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 100 may include one or more system servers 140. The system servers 140 may operate to support the media devices 106 from the cloud. It is noted that the structural and functional aspects of the system servers 140 may wholly or partially exist in the same or different ones of the system servers 140.

The media devices 106 may exist in thousands or millions of media systems 102. Accordingly, the media devices 106 may lend themselves to crowdsourcing embodiments and, thus, the system servers 140 may include one or more crowdsource servers 142.

For example, using information received from the media devices 106 in the thousands and millions of media devices 106, the crowdsource server(s) 142 may identify similarities and overlaps between closed captioning requests issued by different users 132 watching a particular movie. Based on such information, the crowdsource server(s) 142 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 142 may operate to cause closed captioning to be automatically turned on and/or off during future streaming of the movie.

Crowdsource server(s) 142 may further include user interface usage information such as how user(s) 120 interact with the user interface provided through their respective remote control 110 including the usage information described above. Crowdsource server(s) 142 may generate crowdsource user interface information that may identify usage history of the user interface for all remote controls that are connected to crowdsource server(s) 142. The crowdsource user interface information may be implemented as a ranked list identifying user interface elements that are most used by a plurality of users across multiple multimedia environments.

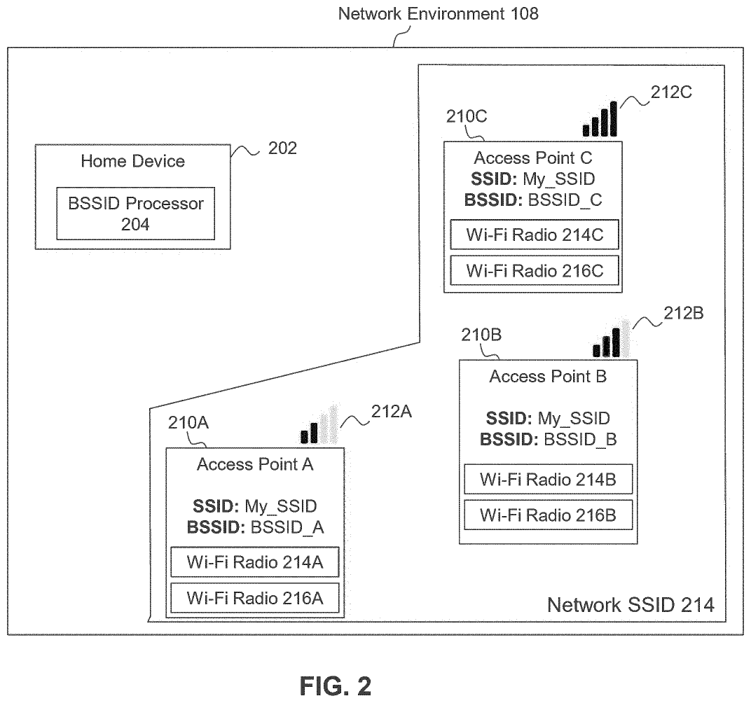

FIG. 2 illustrates a block diagram of an example network environment 108, according to some embodiments. Network environment 108 may include home device 202, which may represent any device implemented in network environment 108 such as display device 104 and media device 106, and network SSID 214. Home device 202 may include a BSSID processor 204 which may be configured to implement an access point selection procedure as further described in this disclosure. Network SSID 214 may be an implementation of network SSID 116.

BSSID processor 204 may be implemented using one or more cores. In some embodiments, each core may be configured to handle different processes or operations of the BSSID selection procedure. For example, BSSID processor 204 may assign operations collecting and processing network metric information for generating a composite metric for each access point to one core and operations for selecting the access point based on the composite metric to another core.

Home device 202 may also include one or more audio decoders and one or more video decoders (not shown). Each audio decoder may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

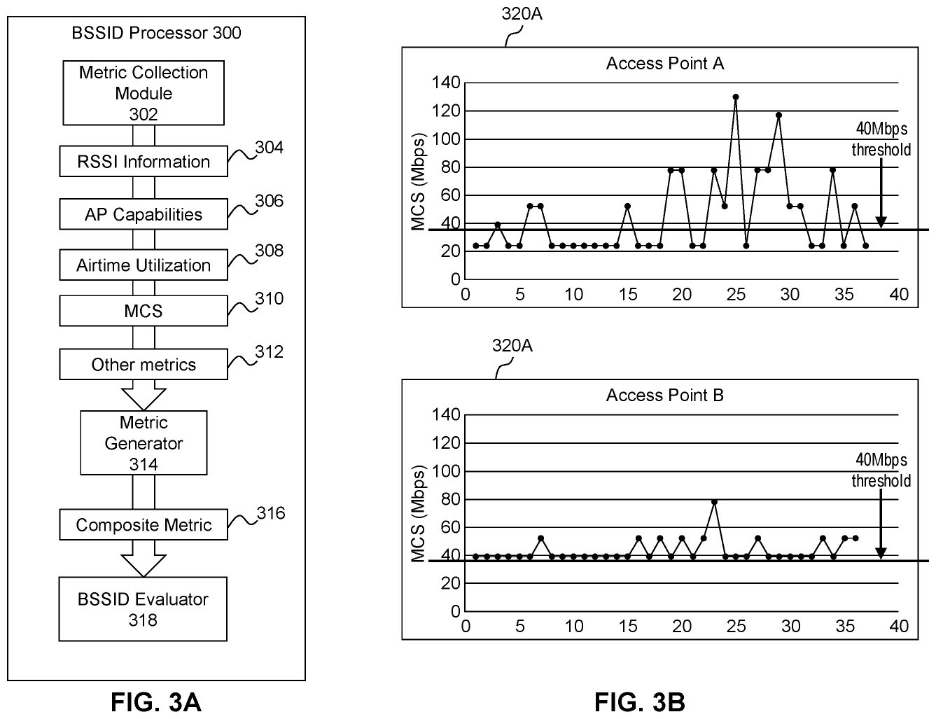

Network SSID 214 may include any number of access points such as access point A 210A, access point B 210B, and access point C 210C. In some embodiments, access points in network SSID 214 have dual-radio functionality capable of forming both different types of connections, such as 2.4 GHz and 5 GHz connections. For example, access point A 210A may be implemented with Wi-Fi radio 214A (e.g., for 2.4 GHz connections) and Wi-Fi radio 216A (e.g., for 5 GHz connections). Access point B 210B and access point C 210C may be similarly configured, with Wi-Fi radio 214B and Wi-Fi radio 216B, and Wi-Fi radio 214C and Wi-Fi radio 216C, respectively. Each access point may also be associated with an SSID of network SSID 214 (e.g., “My SSID”) and a unique BSSID such as “BSSID A” for access point A 210A, “BSSID B” for access point B 210B, and “BSSID C” for access point C. Each access point may also be associated with different network metrics including different RSSI values. For example, access point A 210A may have an RSSI value 212A, access point B 210B may have an RSSI value 212B, and access point C may have an RSSI value 212C. Other types of network metrics that can be monitored by each access point discussed next with respect to FIG. 3.

FIG. 3A illustrates a block diagram of a BSSID processor 300 that may be implemented in a media device for evaluating and selecting access points, according to some embodiments. BSSID processor 300 may be an implementation of BSSID processor 204 and may be configured to collect network metrics, access point capability information, and home device capability information, generating a composite metric (e.g., a speed score) based on this collected information, and evaluating access points based on the generated composite metric. BSSID processor 300 may include metric collection module 302, metric generator 314, and BSSID evaluator 316.

Metric collection module 302 may collect information from access points, such as network metrics and capability information. In some embodiments, the information may be retrieved by BSSID processor 300 during a channel scan of a network and from memory that has stored historical metric information from past channel scans. BSSID processor 300 may use the information to evaluate access points and generate a composite metric for each access point. In some embodiments, this information includes RSSI information 304, AP capabilities 306, airtime utilization 308, modulation coding process (MCS) index 310, and other metrics 312 available to BSSID processor 300. In some embodiments, the composite metric may be referred to as a speed score for the access point and may represent a calculated achievable physical data rate for the access point.

RSSI information 304 refers to the signal strength of the access point. Conventional access point selection relies primarily on RSSI information 304 when selecting an access point. The present disclosure discloses access point selection based on multiple factors including RSSI information 304. These factors include AP capabilities 306, airtime utilization 308, and other metrics 312 such as home device capability and access point reliability.

AP capabilities 306 refers to the network capabilities of the access point which include the Wi-Fi generation (e.g., 802.11n, 11 ac, 11ax), the number of spatial streams supported by the access point, channel bandwidth of the channels provided the access point, and the frequency bands supported by the access point.

Airtime utilization 308 refers to the amount of airtime of an access point that is used by devices connected to the access point. Airtime refers to how much time is available on channels provided by the access point for network communications. In some embodiments, airtime utilization 308 may be provided for each channel provided by access point and may be represented as a percentage of the channel that is used by connected devices. For example, a 75% utilization of a channel represents that devices connected to the access point are utilizing 75% of the channel's capacity to transmit and receive data. Higher utilizations may negatively impact performance for connected devices because there is less airtime for each device to transmit and receive its data. Accordingly, access points with channels having lower airtime utilization 308 may be preferred.

In some embodiments, access points may have multiple channels and devices are connected to one of the multiple channels. Devices connected to an access point may not have visibility into the airtime utilization 308 of channels of other access points to which the devices are not connected. In such embodiments, devices may estimate airtime utilization 308 for these other access points by utilizing average or historical utilization values for the frequency bands supported by the access point, such as 2.4 GHz and 5 GHz. For example, it may be assumed that any channels in the 2.4 GHz band are more congested than channels in the 5 GHz band. For the access point to which devices are currently connected, channel scans may be used to retrieve airtime utilization 308 and devices may measure airtime utilization over a period of time during which the devices are connected to access point and calculate the airtime utilization based on the measured values.

A device connected to the access point that sends or receives data is utilizing the airtime of that access point. Another possible source that may impact airtime utilization 308 are interference from both Wi-Fi devices and other devices in the network environment 108.

MCS 310 is a metric that is provides a snapshot view of the metrics of an existing connection between the access point and a home device. These metrics include the modulation type (i.e., phase and amplitude modulation for bit encoding), the coding rate (i.e., number of bits that transfer information and number of bits for error correction; there being a fixed quantity of bits, the higher the number of bits for transferring information, the less number that is available for error correction), the number of spatial streams being used (a higher number of spatial streams may increase data rate but may be more susceptible to noise and interference), and the channel bandwidth (the size of the channel being used). The value of the MCS may indicate the modulation type, the coding rate, the number of spatial streams being used for communication with the access point. In some embodiments, MCS 310 may be represented as a value in term of megabits per sec (Mbps).

Other metrics 312 may also be used as part of generating the composite metric. In some embodiments, access point reliability may be calculated from a historical monitoring of the MCS 310 for an access point. For example, in some embodiments, MCS 310 may be stored over a particular time period (e.g., one day) and compared to a threshold over that same time period to determine whether the access point has provided consistent network performance; in this embodiment, the network performance is measured based on the MCS 310. In some embodiments, the access point reliability may be calculated from a number of disconnection events over a particular time period (e.g., one day), with access points having fewer disconnection events (higher reliability) being preferred. In other embodiments, reliability may be calculated based on the percentage of time that the connection is available and delivering connection speeds greater than a threshold. Other embodiments will be apparent to those skilled in the art.

FIG. 3B illustrates an exemplary determination of reliability for two access points For example, MCS values for first and second access points may be compared to a 40 Mbps threshold (i.e., the minimum speed needed for 4K streaming). In 320A and 320B, access points A and B have an average MCS of approximately 40 Mbps. In 320A, the MCS values of access point A over a time period are displayed in relation to the 40 Mbps threshold. In 320B, the MCS values of access point B over the same time period are displayed in relation to the same 40 Mbps threshold. In 320A, access point A provides higher values of MCS 310 at various times throughout the time period but also has provided lower values below the 40 Mbps threshold. In contrast, in 320B, access point B consistently provides values of MCS 310 over the 40 Mbps threshold. Accordingly, in one example, the reliability score for access point B may be higher than for access point A since access point B is more consistent at delivering 4K speeds. Other metrics 312 may further include home device capability such as Wi-Fi generation (e.g., 802.11n, 802.11ac, 802.11ax), the number of spatial streams, channel bandwidth, and the frequency band.

Metric generator 314 receives metrics provided by metric collection module 302 and generates a composite metric based on the received metrics. Metric generator 314 may be programmed to combine the metrics according to a predetermined algorithm to generate a single value representing a predicted performance of the access point. Additional embodiments of generating the composite metric is discussed below.

BSSID evaluator 316 uses the generated composite metric of each access point to evaluate and select an access point for establishing a connection within the network environment 108.

### Embodiments of Calculating the Composite Metric and Selecting Access Points

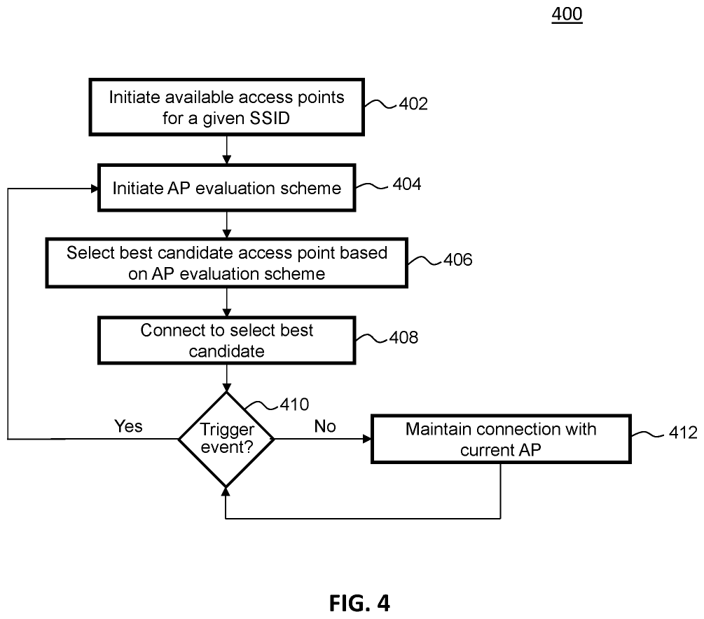

FIG. 4 illustrates a flowchart illustrating a method 400 for selecting an access point, according to some embodiments. As a non-limiting example with regards to FIGS. 1-3, one or more processes described with respect to FIG. 4 may be performed by any home device within a media system 102 such as a media device (e.g., media device 106 of FIG. 1) or a display device (e.g., display device 104 of FIG. 1). In such an embodiment, any of these devices may execute code in memory to perform certain steps of method 400 of FIG. 4. While method 400 of FIG. 4 will be discussed below as being performed by home device 202, other devices or components may store the code and therefore may execute method 400 by directly executing the code. For example, BSSID processor 206 of home device 202 may perform some of or all of the steps. Accordingly, the following discussion of method 400 will refer to devices of FIGS. 1 and 2 as an exemplary non-limiting embodiment of method 400. Moreover, it is to be appreciated that not all steps may be needed to perform the disclosure provided herein. Further, some of the steps may be performed simultaneously or in a different order than shown in FIG. 4, as will be understood by a person of ordinary skill in the art.

In 402, home device 202 identifies a network with which to connect and identifies available access points for that network. The access points share the same SSID for the network. In some embodiments, home device 202 may determine whether there are any known access points in the list of available access points. In some embodiments, home device 202 may store information about access points to which it has previously connected and access points are determined to be known based on the availability of historical network metrics. If there are no known access points, home device 202 may conclude that it likely is connecting to the network for the first time. If so, home device 202 may perform an AP evaluation process based on information that is collected during a first network scan, such as the RSSI information. In some embodiments, home device 202 detects RSSI information for each available access point, generates a composite metric based on the RSSI information, and selects an access point based on the composite metric. After connected to the access point, home device 202 may start collecting network metric information about the access point and other access points in the network so that home device 202 may later execute the AP evaluation process to select a new access point.

In 404, home device 202 initiates the AP evaluation process to select an access point. Home device 202 may already be connected to an access. Instead of selecting an access point based on solely on the signal strength of that access point, home device 202 ranks access points based on the composite score (embodiments for calculating the composite score are discussed below) calculated from a combination of metrics including signal strength, channel, Wi-Fi band, bandwidth, and Wi-Fi protocol. In some embodiments, home device 202 retrieves already calculated composite scores for the available access points and ranks the access points based on the retrieved composite scores. In some embodiments, after retrieving stored composite values the AP evaluation process may also include updating the retrieved composite scores based on current network metric information for each access point.

In 406, home device 202 selects the best candidate access point from the available access points. In some embodiments, home device 202 selects the access point with the highest composite score. As noted above, the composite score may be a reflection of an estimated maximum achievable downlink speed with that access point so an access point with the highest composite score represents an access point with the highest estimated maximum achievable downlink speed. In some embodiments, home device 202 may select an access point that is not the one with the highest composite score. For example, home device 202 may select an access point based on the composite score and other relevant factors such as metrics that were not included in the composite score. In such embodiments, home device 202 may apply weights to the totality of availability network metric information (including the composite metric) and make a decision accordingly.

In 408, host device 202 connects to the selected access point.

In 410, while connected to the selected access point, host device 202 may wait for a trigger condition to initiate the AP evaluation process for determining whether to select another access point to which to connect. Examples of trigger conditions include scheduled events and specified network metric conditions such as degraded signal-to-noise ratio values, congestion, and streaming interruptions or impairments. Trigger conditions are discussed in further detail below. If a trigger condition is detected, then host device 202 may initiate the AP evaluation process at 404 and determine whether a better access point is available. If not, host device 202 maintains the existing connection with the current access point at 412.

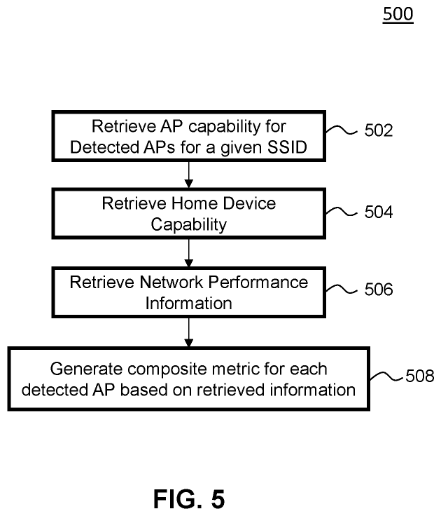

FIG. 5 is a flowchart illustrating a method 500 for collecting information for generating a composite metric for access points in a given network, according to some embodiments. As a non-limiting example with regards to FIGS. 1-3, one or more processes described with respect to FIG. 5 may be performed by any home device within a media system 102 such as a media device (e.g., media device 106 of FIG. 1) or a display device (e.g., display device 104 of FIG. 1). In such an embodiment, any of these devices may execute code in memory to perform certain steps of method 500 of FIG. 5. While method 500 of FIG. 5 will be discussed below as being performed by home device 202, other devices or components may store the code and therefore may execute method 500 by directly executing the code. For example, BSSID processor 206 of home device 202 may perform some of or all of the steps. Accordingly, the following discussion of method 500 will refer to devices of FIGS. 1 and 2 as an exemplary non-limiting embodiment of method 500. Moreover, it is to be appreciated that not all steps may be needed to perform the disclosure provided herein. Further, some of the steps may be performed simultaneously or in a different order than shown in FIG. 5, as will be understood by a person of ordinary skill in the art.

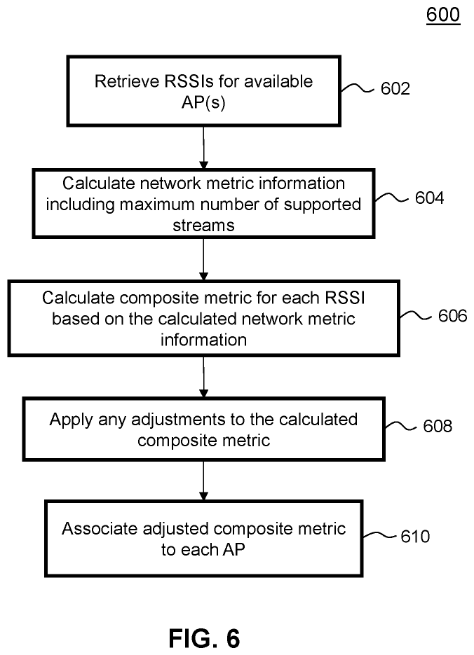

FIG. 5 describes steps performed by home device 202 for collecting network metric information and network device information to be used as part of generating the composite metric for each access point. Specific steps for generating the composite metric are discussed further with respect to FIG. 6.

In 502, home device 202 retrieves the capability information for each detected access point in the network for a given SSID. Capability information for each detected access point can be obtained during the wireless scanning process, and may be present in WiFi beacons and Probe Response frames. In 504, home device 202 retrieves its own capability information. The capability information for access points and home devices include the latest Wi-Fi generation supported by the Wi-Fi radios, the number of spatial streams, channel bandwidths, and supported frequency bands. The capability information may be used to calculate maximum potential values for the number of supported streams, the channel bandwidth, and a mutual Wi-Fi generation between the access points and home devices.

In 506, home device 202 retrieves network performance information about each of the available access points. There are different methods for retrieval that are based on the connection status of the home device 202. For example, if home device 202 is connecting to a network for the first time, home device 202 may perform the AP evaluation scheme based on network information that is collected during the first network scan. Conversely, if home device 202 is reconnecting to a network with known access points, home device 202 may retrieve composite metrics for each access point as well as current network metric information that may be used to update the composite metrics prior to access point selection.

In 508, home device 202 may generate the composite metric for each access point based on the retrieved information in 502, 504, and 506.

FIG. 6 is a flowchart illustrating a method 600 for generating a composite metric based on collected information for access points in a given network, according to some embodiments. As a non-limiting example with regards to FIGS. 1-3, one or more processes described with respect to FIG. 6 may be performed by any home device within a media system 102 such as a media device (e.g., media device 106 of FIG. 1) or a display device (e.g., display device 104 of FIG. 1). In such an embodiment, any of these devices may execute code in memory to perform certain steps of method 600 of FIG. 6. While method 600 of FIG. 6 will be discussed below as being performed by home device 202, other devices or components may store the code and therefore may execute method 600 by directly executing the code. For example, BSSID processor 206 of home device 202 may perform some of or all of the steps. Accordingly, the following discussion of method 600 will refer to devices of FIGS. 1 and 2 as an exemplary non-limiting embodiment of method 600. Moreover, it is to be appreciated that not all steps may be needed to perform the disclosure provided herein. Further, some of the steps may be performed simultaneously or in a different order than shown in FIG. 6, as will be understood by a person of ordinary skill in the art.

In 602, determine signal strength (RSSI) information for each access point including the current access point if the home device 202 is currently connected to the network. For a currently connected access point, in some embodiments, home device 202 may use a time-averaged signal strength over a predetermined time window. The predetermined time window may be adjusted based on network conditions. In some embodiments, a default value, such as 2 hours, may be used and the value may be later adjusted based on network conditions. In some embodiments, signal strength information for the current access point may be retrieved from periodic logs. For other access points in the network (e.g., other access points in the network but to which home device 202 is not currently connected), in some embodiments, the home device 202 may use a time-averaged signal strength from previous channel scans of the network where the number of channel scans may be predetermined (e.g., default value) or dynamically adjusted based on network conditions or performance. In some embodiments, home device 202 may be configured to perform a channel scan on a recurring basis (e.g., one every hour) and is configured to store the results of each channel scan. The results of a channel scan include the signal strength information for each detected access point within the currently connected network.

In 604, home device 202 may calculate network metric information for each access point in the network. Examples of network metric information include a maximum number of supported streams, a maximum channel bandwidth, and a maximum mutually-supported Wi-Fi generation between the home device 202 and each access point. In some embodiments, the maximum number of supported streams may be calculated based on using the minimum value between the number of supported streams of the access point and the number of supported streams of the home device 202. In some embodiments, the maximum channel bandwidth may be calculated based on using the minimum value between the maximum bandwidth of the access point and the maximum bandwidth of the home device 202. In some embodiments, the maximum mutually-supported Wi-Fi generation may be calculated based on the highest version of Wi-Fi generations (e.g., 802.11n, 11 ac, 11ax) that is shared between the highest version of the Wi-Fi generation supported by home device 202 and the highest version of the Wi-Fi generation supported by the access point.

In 606, home device 202 calculates a composite metric for each access point based on the calculated network metric information from 604 and the RSSI information of each access point from 602. Accordingly, each access point may be assigned a composite metric. In some embodiments, the composite metric is time-averaged over a predetermined time period. The composite metric may represent the estimated maximum achievable MCS or date rate for each access point based on the network capability information of the access points and the home device 202, such as the maximum number of supported streams, the maximum channel bandwidth, and the mutual Wi-Fi generation determined in 602. In some embodiments, the calculation may include comparing the values of the maximum number of supported streams and the maximum channel bandwidth with a corresponding entry in a data rate lookup table such as an MCS index table (e.g., 802.11n table, 11ac table, or 11ax table). The data rate lookup table may be configured to provide a maximum achievable data rate for an access point based on certain information including the calculated RSSI information (e.g., time-averaged) and network capabilities of the home device 202 and communication device 230. The MCS index table that is used may be based on the mutual Wi-Fi generation between the access point and the home device 202. In some embodiments, home device 202 may retrieve all possible bandwidths from the MCS index table that are less than or equal to the maximum channel bandwidth and all possible supported streams from the MCS index table that are less than or equal to the maximum number of supported streams, and then selects the maximum bandwidth from these retrieved entries in the MCS index table. Using the MCS index table in this manner allows the calculation of the composite score, and by extension, the access point selection to take into account the access point and home device 202 capabilities (e.g., Wi-Fi generation, number of streams, and channel bandwidth).

In 608, home device 202 may apply any adjustments to the calculated composite metric from 606. Adjustments may be utilized to take account network conditions of the network. In some embodiments, the calculated composite metric from 606 may be adjusted based on a congestion factor associated with a frequency band provided by the access point. For example, the composite metric may be reduced by a certain predefined factor (e.g., 0.6) for 2.4 Ghz and another predefined factor (e.g., 0.8) for 5 Ghz. The predefined factor for 5 Ghz may be greater than the predefined factor for 2.4 Ghz to represent that that 2.4 Ghz connections are typically more congested than 5 Ghz connections. A static value for the factor may be desirable for the congestion adjustment because airtime values cannot be measured during channel scans. The factors represent a historical congestion performance for the respective frequency bands. In some embodiments, the composite metric may be adjusted by a congestion factor that is estimated based on measurements obtained during a channel scan. In some embodiments, the congestion factor for a specific channel is estimated based on the number of access points detected on that channel. In some embodiments, the congestion factor for a specific channel is estimated based on measurements of the airtime utilization values on the channel during the scanning process. In some embodiments, no adjustments are applied to the composite metric.

In some embodiments, when home device 202 is selecting from unknown access points (i.e., first time AP selection), home device 202 may select between access points based on the composite metric that is calculated from a single signal strength measurement (i.e., on the first channel scan of the access points). In some embodiments, when home device 202 has network metric information about access points (i.e., subsequent AP selection), home device 202 may use an average of previous signal strength measurements from a predetermined number of previous channel scans to calculate the composite metric for access points to which home device 202 is not currently connected. For the access point that home device 202 is currently connected, home device 202 may calculate an average of signal strength measurements logged over a predetermined time period in which home device 202 has been connected to the access point. In some embodiments, the home device 202 may calculate an average composite metric based on averaging the values of the composite metric corresponding to a set of measurements of the signal strength over a predetermined time period. In some embodiments, the time average is computed using an exponentially-weighted moving average formula.

In some embodiments, a reliability adjustment may also be used. In some embodiments, reliability may be defined as a percentage of the total number of composite metric values (calculated over a predetermined time period) that exceeds a predetermined threshold value. There may be different predetermined threshold values for different applications. For example, a threshold value of 40 Mbps may be used for 4K streaming and 10 Mbps may be used for 2K streaming. The reliability adjustment may also be based on other network events such as disconnects from the access point within a predefined time period.

In some embodiments, the composite metric may be adjusted based on a calculated airtime utilization value for each access point. For example, the airtime utilization may be another factor that is used to weight the composite metric. The higher the airtime utilization the higher the reduction to the composite metric. In some embodiments, the home device 202 may apply a weight to the composite metric for an access point by calculating a product between the airtime utilization value of the access point and the composite metric. In some embodiments, the home device 202 may sort the access points based on the weighted composite metric and then select an access point from the sorted list based on the reliability associated with each access point.

In 610, home device 202 associates each adjusted composite metric with a respective access point and stores a list associating the composite metrics with the access points for later retrieval and use during the AP selection process.

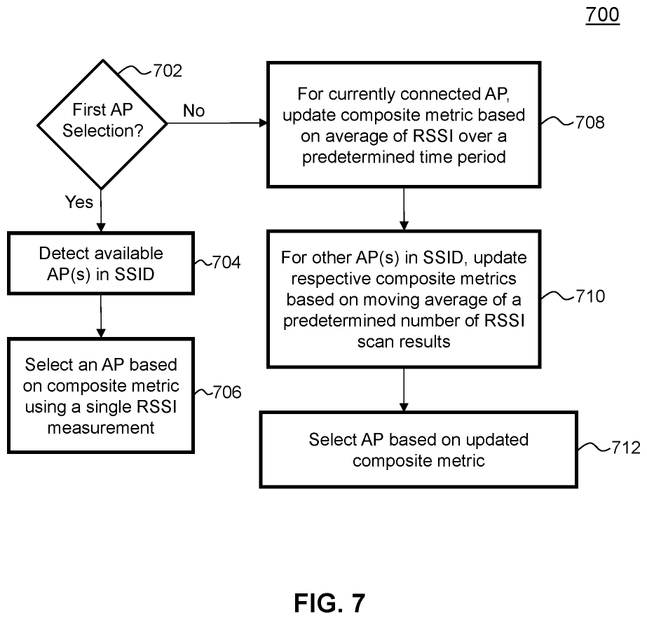

FIG. 7 is a flowchart illustrating a method 700 for selecting an access point based on the speed score of each access point, according to some embodiments. As a non-limiting example with regards to FIGS. 1-3, one or more processes described with respect to FIG. 7 may be performed by any home device within a media system 102 such as a media device (e.g., media device 106 of FIG. 1) or a display device (e.g., display device 104 of FIG. 1). In such an embodiment, any of these devices may execute code in memory to perform certain steps of method 700 of FIG. 7. While method 400 of FIG. 7 will be discussed below as being performed by home device 202, other devices or components may store the code and therefore may execute method 700 by directly executing the code. For example, BSSID processor 206 of home device 202 may perform some of or all of the steps. Accordingly, the following discussion of method 700 will refer to devices of FIGS. 1 and 2 as an exemplary non-limiting embodiment of method 700. Moreover, it is to be appreciated that not all steps may be needed to perform the disclosure provided herein. Further, some of the steps may be performed simultaneously or in a different order than shown in FIG. 7, as will be understood by a person of ordinary skill in the art.

In 702, home device 202 determines whether it has previously connected to any access points in the current network SSID. If not, home device 202 initiates a first-time AP selection procedure at 704. If so, then home device 202 initiates an AP evaluation process for selecting among the known access points for which home device 202 has network information.

In 704, home device 202 performs a first channel scan and detects the available access points in the network. Home device 202 retrieves signal strength information for each access point during the first channel scan.

In 706, home device 202 selects an access point based on a composite metric based on network information collected during a first channel scan. Home device 202 calculates a composite metric based on the signal strength information and ranks the access points based on the calculated composite metrics for each access point. Home device 202 may then select the highest ranked access point based on the composite metric.

In 708, home device 202 may update the composite metric for the current access point to which home device 202 is connected. In some embodiments, this update may include taking an average of the signal strength information stored by home device 202 over a predetermined period of time and using the averaged signal strength information to update the composite metric. In some embodiments, this update may include taking an average of the composite metric values over a predetermined period of time from the composite metric information stored by home device 202 and using the instantaneous signal strength information to update the composite metric. In some embodiments, the average of the composite metric values is computed using an exponentially-weighted moving average formula.

In some embodiments, instead of averaging the signal strength information, home device 202 calculates an instantaneous composite metric at each instant based on the latest signal strength information and other network metric information from the last channel scan. Home device 202 may then compute a time-average of the instantaneous composite metrics from previous scans. In an embodiment, this computation may be done using an exponentially-weighted moving average formula. That is, home device 202 calculates an average composite metric over a predetermined period of time for each access point and uses the time-averaged composite metric as the composite metric.

In 710, home device 202 may update the composite metrics for the other access points in the same network as the current access point. Home device 202 may use signal strength information from a predetermined number of previous channel scan results by averaging the signal strength information from these results for each access point. Home device 202 may then update the composite score for each access point based on this updated signal strength average.

In 712, home device 202 may then decide whether to switch from the current access point (by selecting another access point in the network) based on the updated composite metrics for each of the access points in the network. This decision may be based on the access point having the highest composite metric of the updated composite metrics calculated at 708 and 710.

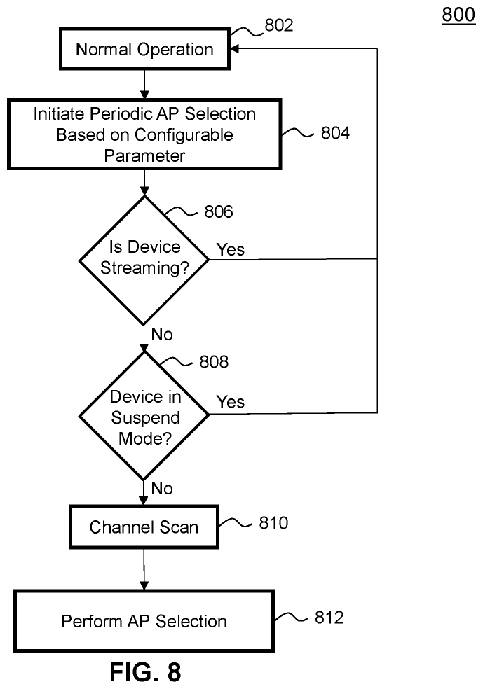

FIG. 8 is a flowchart illustrating a method 800 for initiating periodic AP selection, according to some embodiments. As a non-limiting example with regards to FIGS. 1-3, one or more processes described with respect to FIG. 8 may be performed by any home device within a media system 102 such as a media device (e.g., media device 106 of FIG. 1) or a display device (e.g., display device 104 of FIG. 1). In such an embodiment, any of these devices may execute code in memory to perform certain steps of method 800 of FIG. 8. While method 800 of FIG. 8 will be discussed below as being performed by home device 202, other devices or components may store the code and therefore may execute method 800 by directly executing the code. For example, BSSID processor 206 of home device 202 may perform some of or all of the steps. Accordingly, the following discussion of method 800 will refer to devices of FIGS. 1 and 2 as an exemplary non-limiting embodiment of method 800. Moreover, it is to be appreciated that not all steps may be needed to perform the disclosure provided herein. Further, some of the steps may be performed simultaneously or in a different order than shown in FIG. 8, as will be understood by a person of ordinary skill in the art.

In 802, home device 202 is connected to an access point and is operating as normal.

In 804, a predetermined recurrence parameter may trigger home device 202 to perform periodic AP selection. For example, the recurrence parameter may indicate a scheduled time to perform periodic AP selection or indicate a predetermined number of times that home device 202 performs the selection process to account for any changes in signal and environment. In some embodiments, the recurrence parameter may specify a frequency (e.g., one every hour to perform periodic AP selection.

In 806, home device 202 determines whether it is currently streaming. In some embodiments, periodic AP selection is restricted to run when a device is not streaming so as to not impact the user experience. If so, then home device 202 returns to normal operation at 802 and waits until another periodic AP selection process is initiated. If not, home device 202 proceeds to 808.

In 808, home device 202 determines whether it is currently in power save or suspend mode. In some embodiments, periodic AP selection is restricted to run when a device is not in either power save or suspend mode. If so, then home device 202 returns to normal operation at 802. If not, home device 202 proceeds to 810.

In 810, home device 202 performs a channel scan of available access points within the network. Home device 202 collects network metric information, such as the airtime or noise, from the access points as a result of the channel scan.

In 812, home device 202 may then perform the periodic AP selection process as discussed with respect to FIG. 7. In some embodiments, the channel scans may occur at a different frequency than the AP selection process as the purpose of the channel scan is to collect network information to be used for the AP selection process. Accordingly, it is not necessary to perform the AP selection process every time a channel scan is performed. There may be different frequencies assigned to the channel scan and to the AP selection process.

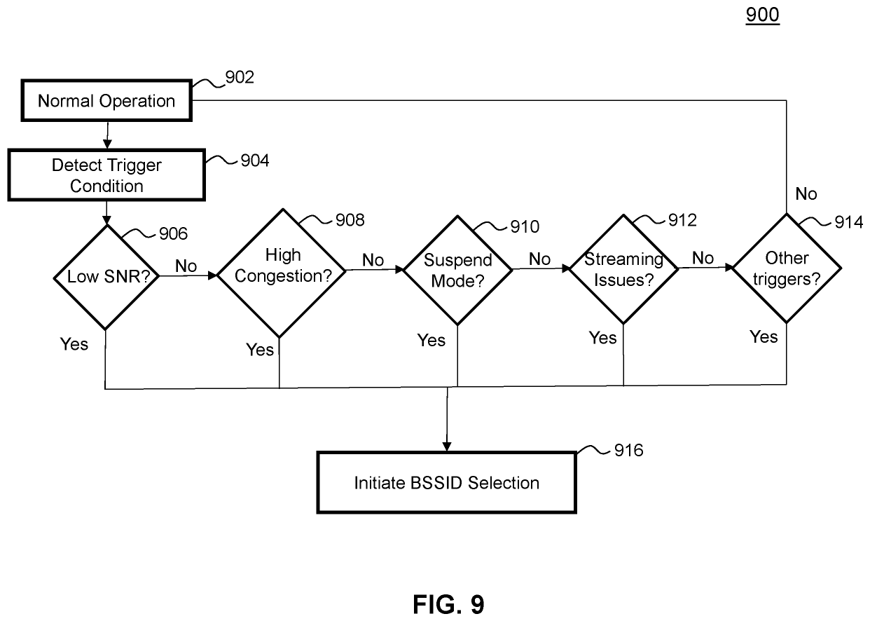

FIG. 9 is a flowchart illustrating a method 900 for initiating AP selection based on a detected trigger condition, according to some embodiments. As a non-limiting example with regards to FIGS. 1-3, one or more processes described with respect to FIG. 9 may be performed by any home device within a media system 102 such as a media device (e.g., media device 106 of FIG. 1) or a display device (e.g., display device 104 of FIG. 1). In such an embodiment, any of these devices may execute code in memory to perform certain steps of method 900 of FIG. 9. While method 900 of FIG. 9 will be discussed below as being performed by home device 202, other devices or components may store the code and therefore may execute method 900 by directly executing the code. For example, BSSID processor 206 of home device 202 may perform some of or all of the steps. Accordingly, the following discussion of method 900 will refer to devices of FIGS. 1 and 2 as an exemplary non-limiting embodiment of method 900. Moreover, it is to be appreciated that not all steps may be needed to perform the disclosure provided herein. Further, some of the steps may be performed simultaneously or in a different order than shown in FIG. 9, as will be understood by a person of ordinary skill in the art.

In 902, home device 202 is connected to an access point and is operating as normal.

In 904, home device 202 detects a potential trigger condition such as a change in network conditions or network performance that causes home device 202 to perform access point selection.

In 906, home device 202 determines whether the potential trigger condition involves a drop in the signal-noise ratio (SNR) of the access point where the value of the SNR is now below a predetermined threshold value. If so, home device 202 may initiate access point selection at 916. If not, home device 202 proceeds to 908.

In 908, home device 202 determines whether the potential trigger condition involves a congestion above a predetermined threshold. In some embodiments, congestion may be determined based on airtime utilization on a current channel of the access point and whether the airtime utilization value is above a predetermined utilization rate for a predetermined time period. As a non-limiting example, a trigger condition may be set if the airtime utilization over the last two hours exceeds 20%. If home device 202 detects a trigger condition involving congestion, home device 202 may initiate access point selection at 916. If not, home device 202 proceeds to 910.

In 910, home device 202 determines whether the potential trigger condition involves detecting a transition into a suspend mode on the home device 202. On certain home devices that automatically enter a suspend mode when not streaming content, there is not much free time to perform an AP selection process because the home device is either streaming or automatically entering a suspend mode. Accordingly, a trigger condition may be set to perform the AP selection when home device 202 detects that it is about to enter a suspend mode and the performs the AP selection process prior to entering the suspend mode. If home device 202 detects a trigger condition involving a suspend mode, home device 202 may initiate access point selection at 916 prior to transitioning to the suspend mode. If not, home device 202 proceeds to 912.

In 912, home device 202 determines whether the potential trigger condition involves detecting any streaming issues with a current streaming session. Examples of streaming issues include buffering and audio packet dropouts. In some embodiments, any detected buffering or dropouts may be used as a trigger condition. In some embodiments, home device 202 may wait to initiate the AP selection until after the current streaming session is completed because switching access points during a streaming session would negatively impact streaming content and the user experience. Accordingly, home device 202 may delay performing the AP switching procedure until it detects that the streaming session has ended. If home device 202 detects a trigger condition involving streaming issues, home device 202 may initiate access point selection at 916. If not, home device 202 proceeds to 912.

In 914, home device 202 determines whether the potential trigger condition involves any other trigger conditions associated with noise and congestion at the current access point. If home device 202 detects a trigger condition involving any other trigger conditions, home device 202 may initiate access point selection at 916. If not, home device 202 proceeds to 902 and continues normal operations.

In 916, home device 202 initiates an AP selection process as described in FIG. 7. In some embodiments when home device 202 is not free to initiate an AP selection process at that time, the home device 202 may schedule the AP selection process to occur at the next detected idle time. In some embodiments, an idle time is defined as a time when no streaming or user activity is occurring or has occurred within a predetermined duration.

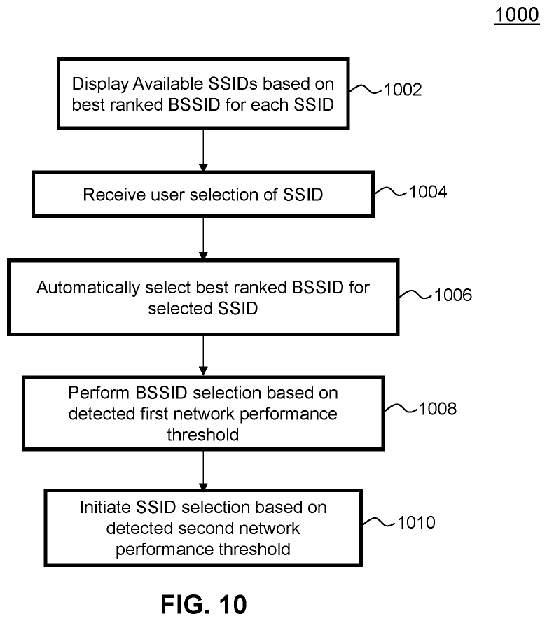

FIG. 10 is a flowchart illustrating a method 1000 for selecting a network based on composite metric of associated access points in the network during a setup connection process, according to some embodiments. As a non-limiting example with regards to FIGS. 1-3, one or more processes described with respect to FIG. 10 may be performed by any home device within a media system 102 such as a media device (e.g., media device 106 of FIG. 1) or a display device (e.g., display device 104 of FIG. 1). In such an embodiment, any of these devices may execute code in memory to perform certain steps of method 1000 of FIG. 10. While method 1000 of FIG. 10 will be discussed below as being performed by home device 202, other devices or components may store the code and therefore may execute method 1000 by directly executing the code. For example, BSSID processor 206 of home device 202 may perform some of or all of the steps. Accordingly, the following discussion of method 1000 will refer to devices of FIGS. 1 and 2 as an exemplary non-limiting embodiment of method 1000. Moreover, it is to be appreciated that not all steps may be needed to perform the disclosure provided herein. Further, some of the steps may be performed simultaneously or in a different order than shown in FIG. 10, as will be understood by a person of ordinary skill in the art.

In 1002, home device 202 has initiated a setup connection process for a wireless network among multiple available wireless networks. As a first part of this process, home device 202 may display the available wireless networks on a graphical user interface. In some embodiments, the display may include ordering the available wireless networks based an order of the composite metrics of respective access points in each available wireless network. That is, the wireless network having an access point with the highest composite metric may be displayed first, the wireless network having an access point with the next highest composite metric may be displayed next, and so on.

In 1004, home device 202 receives a user selection of an available network. For example, the user selection may be provided via a user input on the graphical user interface.

In 1006, home device 202 automatically selects the highest ranked access point for the selected network. As noted above, the ranking of access points is based on the generated composite score for each access point. In embodiments where home device 202 is performing a connectivity check, home device 202 may the verify the network connection after selecting the highest ranked access point.

Steps 1008 and 1010 represent a two-tiered threshold for determining when to display a network selection screen to prompt the user to select a new network SSID.

In 1008, after selection the network, home device 202 may perform an access point selection process based on a detected first network performance threshold. In some embodiments, the network performance threshold may be a predetermined number of buffering attempts. For example, if home device 202 detects two buffer attempts, home device 202 may initiate selection of an access point based on composite metrics for each access point. Home device 202 may rely on previously stored composite metrics or may initiate the composite metrics for each access point prior to selection. If there is another access point within the network that has a higher composite metric than the current access point, home device 202 may automatically switch to the new access point without requiring user action or approval. In some embodiments, home device 202 performs a channel scan of access points within the current network and receives current signal strength information from each access point.

In 1010, home device 202 may continue to detect problems with the network over a predetermined time period. Home device 202 may initiate selection of a new network SSID if network problems continue. That is, if home device 202 detects a second network performance threshold (which is higher than the first network performance threshold), then home device 202 may initiate network selection. For example, if home device 202 detects four buffering events over a thirty minute span, home device 202 may display the available wireless networks that have access points with higher composite metrics than the current network and prompt the user to select a new network to which to connect.

### Example Computer System

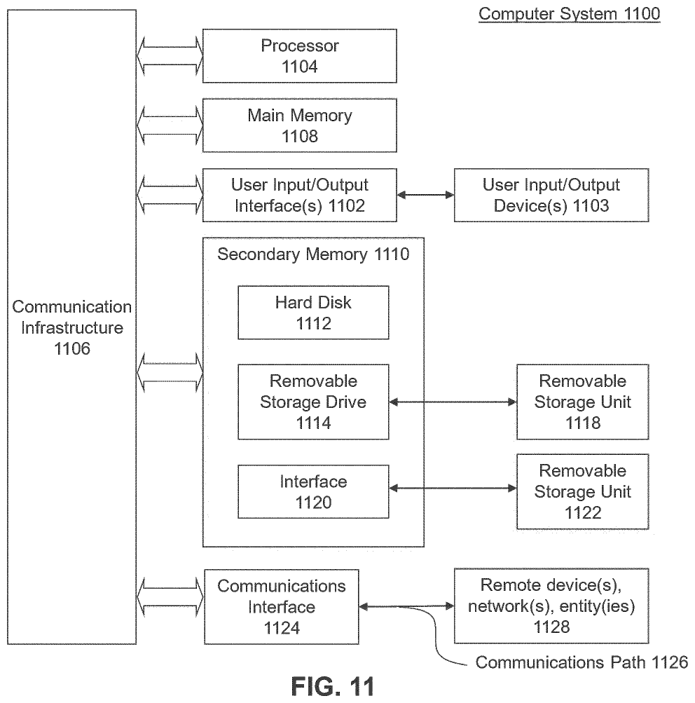

Various embodiments may be implemented, for example, using one or more well-known computer systems, such as computer system 1100 shown in FIG. 11. For example, the media device 106 may be implemented using combinations or sub-combinations of computer system 1100. Also or alternatively, one or more computer systems 1100 may be used, for example, to implement any of the embodiments discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100 or processor(s) 1104), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method performed by a media device for selecting an access point from a plurality of access points in a network associated with a plurality of composite metrics, wherein the plurality of access points comprises a first access point associated with a first composite metric and a second access point associated with a second composite metric, the method comprising:
calculating a signal strength value for each access point in the plurality of access points, wherein the signal strength value for each access point comprises a first signal strength value for the first access point and a second signal strength value for the second access point;
determining the first composite metric for the first access point based on the first signal strength value, at least one network capability of the media device, and at least one network capability of the first access point;
determining the second composite metric for the second access point based on the second signal strength value, the at least one network capability of the media device, and at least one network capability of the second access point; and
selecting the access point from the plurality of access points based on at least the first composite metric and the second composite metric.

2. The method of claim 1, wherein the signal strength value represents a time-averaged value based on signal strength information associated with each access point and a predetermined time window.

3. The method of claim 1, wherein the determining the first composite metric and the second composite metric further comprises:
identifying a first maximum data rate of the first access point by performing a first lookup in a data rate table, wherein the first lookup utilizes the first signal strength value, the at least one network capability of the media device, and the at least one network capability of the first access point and wherein the first composite metric is set equal to the first maximum data rate;
identifying a second maximum data rate of the first access point by performing a second lookup in the data rate table, wherein the second lookup utilizes the second signal strength value, the at least one network capability of the media device, and the at least one network capability of the second access point, and wherein the second composite metric is set equal to the second maximum data rate.

4. The method of claim 1, wherein the at least one network capability of the first access point comprises a maximum number of supported streams of the first access point, a maximum channel bandwidth of the first access point, and a maximum bandwidth of the first access point and the at least one network capability of the media device comprises a maximum number of supported streams of the media device, a maximum channel bandwidth of the media device, and a maximum bandwidth of the media device.

5. The method of claim 4, wherein the determining the first composite metric comprises:
identifying a first corresponding entry in a data rate lookup table based on the at least one network capability of the first access point and the network capability of the media device; and
identifying a second corresponding entry in the data rate lookup table based on the at least one network capability of the second access point and the network capability of the media device.

6. The method of claim 5, wherein the first corresponding entry indicates a maximum achievable data rate of the first access point based on the at least one network capability of the first access point and the second corresponding entry indicates a maximum achievable data rate of the second access point based on the at least one network capability of the second access point.

7. The method of claim 4, wherein the determining the first composite metric comprises:
calculating a maximum number of supported streams between the media device and the first access point based on determining a minimum number of supported streams between the maximum number of supported streams of the first access point and the maximum number of supported streams of the media device; and
determining the first composite metric based on the maximum number of supported streams between the media device and the first access point.

8. The method of claim 4, wherein the determining the first composite metric comprises:
calculating a maximum channel bandwidth between the media device and the first access point based on determining a minimum bandwidth between the maximum bandwidth of the first access point and the maximum bandwidth of the media device; and
determining the first composite metric based on the maximum channel bandwidth between the media device and the first access point.

9. The method of claim 4, wherein the determining the first composite metric comprises:
calculating a maximum mutually-supported Wi-Fi generation between the media device and the first access point based on determining a highest version of Wi-Fi generations that is shared between the media device and the first access point; and
determining the first composite metric based on the maximum mutually-supported Wi-Fi generation between the media device and the first access point.

10. The method of claim 1, wherein the at least one network capability of the second access point comprises a maximum number of supported streams by the second access point, a maximum channel bandwidth of the second access point, and a maximum mutually-supported Wi-Fi generation between the media device and the second access point.

11. A media device for selecting an access point from a plurality of access points in a network associated with a plurality of composite metrics, wherein the plurality of access points comprises a first access point associated with a first composite metric and a second access point associated with a second composite metric, comprising:
at least one processor configured to perform operations comprising:
calculating a signal strength value for each access point in the plurality of access points, wherein the signal strength value for each access point comprises a first signal strength value for the first access point and a second signal strength value for the second access point;
determining the first composite metric for the first access point based on the first signal strength value, at least one network capability of the media device, and at least one network capability of the first access point;
determining the second composite metric for the second access point based on the second signal strength value, the at least one network capability of the media device, and at least one network capability of the second access point; and
selecting the access point from the plurality of access points based on at least the first composite metric and the second composite metric.

12. The media device of claim 11, wherein the signal strength value represents a time-averaged value based on signal strength information associated with each access point and a predetermined time window.

13. The media device of claim 11, wherein in determining the first composite metric and the second composite metric, the operations further comprise:
identifying a first maximum data rate of the first access point by performing a first lookup in a data rate table, wherein the first lookup utilizes the first signal strength value, the at least one network capability of the media device, and the at least one network capability of the first access point and wherein the first composite metric is set equal to the first maximum data rate;
identifying a second maximum data rate of the first access point by performing a second lookup in the data rate table, wherein the second lookup utilizes the second signal strength value, the at least one network capability of the media device, and the at least one network capability of the second access point, and wherein the second composite metric is set equal to the second maximum data rate.

14. The media device of claim 11, wherein the at least one network capability of the first access point comprises a maximum number of supported streams of the first access point, a maximum channel bandwidth of the first access point, and a maximum bandwidth of the first access point and the at least one network capability of the media device comprises a maximum number of supported streams of the media device, a maximum channel bandwidth of the media device, and a maximum bandwidth of the media device.

15. The media device of claim 14, wherein in determining the first composite metric, the operations further comprise:
identifying a first corresponding entry in a data rate lookup table based on the at least one network capability of the first access point and the network capability of the media device; and
identifying a second corresponding entry in the data rate lookup table based on the at least one network capability of the second access point and the network capability of the media device.

16. The media device of claim 15, wherein the first corresponding entry indicates a maximum achievable data rate of the first access point based on the at least one network capability of the first access point and the second corresponding entry indicates a maximum achievable data rate of the second access point based on the at least one network capability of the second access point.

17. The media device of claim 14, wherein the determining the first composite metric comprises:
calculating a maximum number of supported streams between the media device and the first access point based on determining a minimum number of supported streams between the maximum number of supported streams of the first access point and the maximum number of supported streams of the media device; and
determining the first composite metric based on the maximum number of supported streams between the media device and the first access point.

18. The media device of claim 14, wherein the determining the first composite metric comprises:
calculating a maximum channel bandwidth between the media device and the first access point based on determining a minimum bandwidth between a maximum bandwidth of the first access point and a maximum bandwidth of the media device; and
determining the first composite metric based on the maximum channel bandwidth between the media device and the first access point.

19. The media device of claim 14, wherein the determining the first composite metric comprises:
calculating a maximum mutually-supported Wi-Fi generation between the media device and the first access point based on determining a highest version of Wi-Fi generations that is shared between the media device and the first access point; and
determining the first composite metric based on the maximum mutually-supported Wi-Fi generation between the media device and the first access point.

20. A non-transitory computer-readable medium having instructions stored thereon that, when executed by at least one computing device, cause the at least one computing device to perform operations for selecting an access point from a plurality of access points in a network associated with a plurality of composite metrics, wherein the plurality of access points comprises a first access point associated with a first composite metric and a second access point associated with a second composite metric, the operations comprising:
calculating a signal strength value for each access point in the plurality of access points, wherein the signal strength value for each access point comprises a first signal strength value for the first access point and a second signal strength value for the second access point;
determining the first composite metric for the first access point based on the first signal strength value, at least one network capability of the media device, and at least one network capability of the first access point;
determining the second composite metric for the second access point based on the second signal strength value, the at least one network capability of the media device, and at least one network capability of the second access point; and
selecting the access point from the plurality of access points based on at least the first composite metric and the second composite metric.
